(19) United States
(12) Patent Application Publication
(10) Pub. No.: US 2008/0163191 A1
(43) Pub. Date: Jul. 3, 2008

(54) SYSTEM AND METHOD FOR FILE TRANSFER MANAGEMENT

(75) Inventors: LeeAnn L. Kania, Loveland, CO (US); Joy L. Mann, West Sand Lake, NY (US); Robert F. Pryor, Lynn Haven, FL (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 11/616,334

(22) Filed: Dec. 27, 2006

(51) Int. Cl. G06F 9/44

(52) U.S. Cl. 717/173

(57) ABSTRACT

Through methods, systems and program codes, a file download URL is used to navigate to a download server, the download server downloading or not downloading a file to a party in response to the URL without communicating with a backend server or performing a party demographic information look-up, the download server also logging a complete download of the file to a party pointer database file. Download URL formation may be dependent upon approval of party demographic information. URL signed parameter strings comprise file name, party pointer, expiration and file type parameters. Download reporting comprises searching a database for party pointers associated with successful file downloads, compiling pointers associated with successful downloads and generating an export file for a downloaded file listing parties from demographic information indexed by associated pointers. In one aspect, a download server logs a flat file into a database in response a complete file download.

### FIELD OF THE INVENTION

The present invention relates to devices, and methods and systems for managing file transfers between different computers, and more particularly for efficiently correlating user demographic information with file transfer information.

### BACKGROUND OF THE INVENTION

The transfer of digital information is often accomplished through the use of client terminal devices such as remote computers, PDAs and cellular telephones in communication with network computers and services through the Internet, WAN (wide area network), LAN (local area network) and other communication mediums. However, although file transfer processes are generally simple to initiate and complete from a downloading client's perspective, achieving a file download may impose significant processing and reporting burdens on the file provider. More particularly, governmental export regulations generally identify parties, entities or geographic locations (i.e. other nations) that are prohibited from receiving certain files or file types, sometimes in the interest of national security. And for permitted file downloads, detailed reporting requirements may also be imposed upon the file provider.

Thus a network file provider must generally acquire specific demographic information with regard to each file request, verify that the requested file can be legally downloaded by the requesting party in view of the demographic information, and then generate and provide specified reports with respect to file properly downloaded. Typically demographic information is entered by the requesting party, and/or observed by a backend server, and validated in view of the relevant regulation, laws, network administration rules, etc. by a backend server process before a requested file may be downloaded.

File downloading thus generally requires that the server holding the file (the download server) communicate with at least one backend server resource, which must also successfully validate the file request through look-up routines or other process steps. Additionally, each resumption of an interrupted download or additional file request requires either reentry of required demographic information or another backend server validation, thereby imposing data entry and retrieval burdens on both file requesters and file providers. Some efficiencies may be gained by utilizing user identification credential and password methods for previously validated parties, enabling file access through validated log in routines and eliminating some repetitive demographic data requests and entries. However, backend server routines and resources are still required to validate each party login for a file download request. And therefore a file download request will fail with the failure of the backend server resource or of the communications therewith.

Additionally, when a download page is created on a first server and a file referenced thereon downloaded from a second server, download of the file will generally require that party demographic or other identification information (for example, customer numbers, names or other unique identifiers) must be successfully passed between the first and second servers. Still further, when a validated download is interrupted and an attempt is made to resume the download in a subsequent download request from a different physical location, the subsequent request may be denied by a backend server if user identification indicia no longer correlate with the original download request physical location. Therefore, a download request by a party verified and authorized may nonetheless fail by a backend server denial.

Complying with download reporting may also be cumbersome and complex for a file provider under prior art methods and systems. For example, a backend server must generally create a record of each file download upon completion which includes file identification, date and time of download, and a duplication of previously entered and verified demographic information, resulting in multiple duplicate demographic information entries for each party successfully downloading multiple files. Moreover, downloads are rarely accomplished by using a single network connection or server resource, and thus a single download request may result in multiple demographic information lookups and validations, and in a corresponding plurality of log entries that must be identified, collected and compiled into one single entry for a governmental export report.

Thus there is a need for improved file download management and reporting techniques, methods and systems.

### SUMMARY OF THE INVENTION

According to the present invention a method is provided comprising creating a first file download URL with a file name parameter and a party pointer. A party uses the URL to navigate to a download server, the download server downloading or not downloading a first file to the party in response to at least one of the file name parameter and the party pointer without communicating with a backend server or performing a first party demographic information look-up, the download server logging a complete download of the file to a first party pointer database file.

In one aspect the method comprises associating the party pointer with party demographic information, wherein creating the download URL is dependent upon approval of party demographic information in view of a download permission rule. In another aspect the method comprises forming the file download URL with a signed parameter string comprising the file name parameter and the party pointer, and also with a filename reference outside of the signed string, the download server downloading or not downloading the first file by comparing the signed string file name parameter to the filename reference and not downloading the file if the signed string file name parameter does not match the filename reference.

In one aspect the signed parameter string further comprises an expiration date parameter, and the method comprises the download server downloading or not downloading the file by determining an elapsed time from the expiration date parameter and not downloading the file if the elapsed time exceeds a permitted time period. In another aspect the method comprises the party using the URL to navigate to the download server from a second IP address, wherein first and second IP addresses are identified as originating from a common national entity, the download server resuming downloading without communicating with a backend server or performing a first party demographic information look-up.

In another aspect the signed parameter string further comprises a file type parameter, wherein the method comprises creating the file download URL dependent upon approval of the first party demographic information in view of the file type parameter. And in another aspect the method comprises searching a database for party pointers associated with a successful download of the first file, compiling all party pointers associated with successful downloads of the first file, and generating an export file for the first file listing all parties from demographic information indexed by each of the party pointers associated with successful downloads. In one aspect the method comprises storing first party demographic information in a database, wherein the party pointer points to the stored first party demographic information.

In another aspect a system is provided comprising a download server configured to download or not download a first file to first party navigating to the download server through from a first IP address by using a first file download URL without communicating with a backend server or performing a first party demographic information look-up, the download server is further configured to download or not download the first file in response to determining whether the URL is valid. In one aspect the download server is configured to log a flat file into a database in response a complete download of the first file to the first party.

Additionally, a system is provided wherein the first file download URL may comprise a signed parameter string comprising a first file name parameter and a first party pointer, and a first filename reference outside of the signed string, wherein the first party pointer is associated with first party demographic information stored in a database demographic file. In another aspect the signed parameter string further comprises an expiration date parameter, and the download server is configured to determine an elapsed time from the expiration date parameter and not download the first file to the first party if the elapsed time exceeds a permitted time period. Moreover, a system is provided wherein the download server is configured to resume downloading of the first file to the first party at a second IP address without communicating with a backend server or performing a first party demographic information look-up, the first and second IP addresses originating from a common national entity.

In another aspect a system comprises a reporting component configured to compile all party pointers associated with successful downloads of a file and generate an export file for the file listing all parties from demographic information indexed by each of the party pointers associated with successful downloads. In another aspect the signed parameter string further comprises a file type parameter.

In another aspect a method is provided for producing computer executable program code and providing the program code to be deployed to and executed on a computer system, for example by a service provider who offers to implement, deploy, and/or perform functions for others. Still further, an article of manufacture comprising a computer usable medium having the computer readable program embodied in said medium may be provided. The program code comprises instructions which, when executed on the computer system, cause the computer system to create a first file download URL comprising at least a first file name parameter and a first party pointer; cause a download server to download or not download a first file to a first party client in response to the client navigating to the download server through use of the first file download URL in response to at least one of a first file download URL first file name parameter and a first file download URL first party pointer without communicating with a backend server or performing a first party demographic information look-up; and cause the download server to log a complete download of the file to a first party pointer database file.

In one aspect the program code, when executed on the computer system, further causes the computer system to associate the first party pointer with first party demographic information and create the first file download URL dependent upon approval of the first party demographic information in view of a download permission rule. In another aspect the program code, when executed on the computer system, further causes the computer system to form the first file download URL with a signed parameter string comprising the first file name parameter and the first party pointer, and a first filename reference outside of the signed string; and cause the download server to compare the signed string first file name parameter to the first filename reference and not download the first file if the signed string first file name parameter does not match the first filename reference.

In another aspect the program code, when executed on the computer system, further causes the computer system to form the first file download URL signed parameter string with an expiration date parameter, and cause the download server to determine an elapsed time from the expiration date parameter and not download the first file if the elapsed time exceeds a permitted time period. And still further, the program code, when executed on the computer system, may further cause the computer system to search a database comprising a plurality of party pointers for party pointers associated with a successful download of the first file; compile all party pointers associated with successful downloads of the first file; and generate an export file for the first file listing all parties from demographic information indexed by each of the party pointers associated with successful downloads.

### BRIEF DESCRIPTION OF THE DRAWINGS

These and other features of this invention will be more readily understood from the following detailed description of the various aspects of the invention taken in conjunction with the accompanying drawings in which:

FIG. 1 illustrates a process for downloading files according to the present invention.

FIG. 2 illustrates a URL link according to the present invention.

FIG. 3 illustrates a computer system appropriate for file downloading according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections

I. General Description

II. Computerized Implementation

### I. General Description

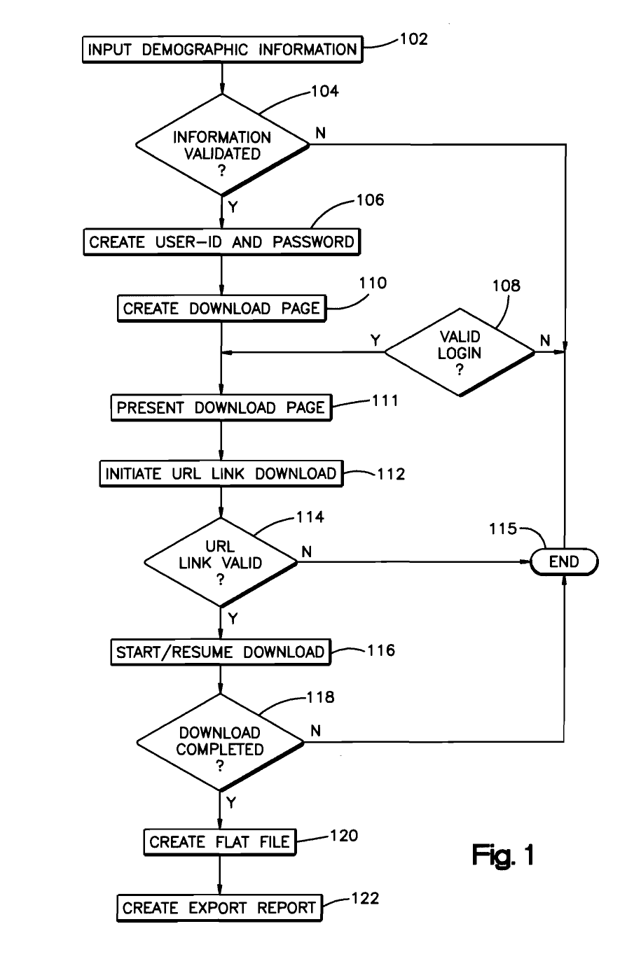

Referring now to FIG. 1, a method for downloading files according to the present invention is illustrated. At 102 a party requesting a file download provides his demographic information. In one embodiment configured to condition and report downloading in response to governmental export regulations and requirements, the demographic information includes three critical demographic categories: downloading party identity indicia (name, title, etc.), corporate or other entity associated with the party where applicable, and geographic location of the download request (including identity of nation or governmental authority associated with the IP address used by the party to access the download web page). Other demographic information may also be requested or required, such as account, shipping or method of payment information (credit card, etc.) Demographic data may actively entered by the party, for example as keyboard text, biometric inputs (eye scans, fingerprint reader inputs, etc.) or other input; or through passive means, for example wherein a backend server observes a party's IP address.

At 104 the demographic information is checked and verified as appropriate for the download activities requested. In an embodiment configured to comply with governmental export regulations a backend server validates each download request by requiring complete entry of and evaluation at least the three critical demographic categories against prohibited lists or databases, wherein the download is invalidated upon a prohibited list entry hit. Other useful information requirements may also be apparent to one skilled in the art, and the present invention is not limited to the illustrative examples provided herein.

Upon complete entry and verification of the prerequisite demographic information and validation for file download at 104 the party may optionally be offered an opportunity to create a unique user ID and password for association with the approved demographic information at 106. This enables the party to avoid reentering the demographic information for subsequent download requests and download resumptions by enabling the party to log in at 108, thus simplifying and streamlining the download process for the requesting party. In the present embodiment a backend server looks-up the previously provided and associated demographic information at 108 and either validates the party for file download or denies the login request. If the party is not validated for the file or files requested at 104, or the log in fails at 108, then the process ends at 115.

Alternatively, upon validation of the party at 104 a download page is dynamically created at 110 comprising one or more unique download URLs, one for each file validated for download. At 111 the page is then presented to a party validated at 104 or successfully logged in at 108, wherein download of a desired file is initiated by “clicking” on an associated URL link on the download page. Each URL link is unique to the party and to the file requested, wherein download of the requested file is conditioned upon recognition by the download server of that the URL is valid at 114. More particularly, file downloading at 116 is enabled by a valid URL at 114 without a backend server resource routine or step, thus eliminating the need for backend server communications and process steps required in the prior art and providing advantages through improved system and method efficiencies.

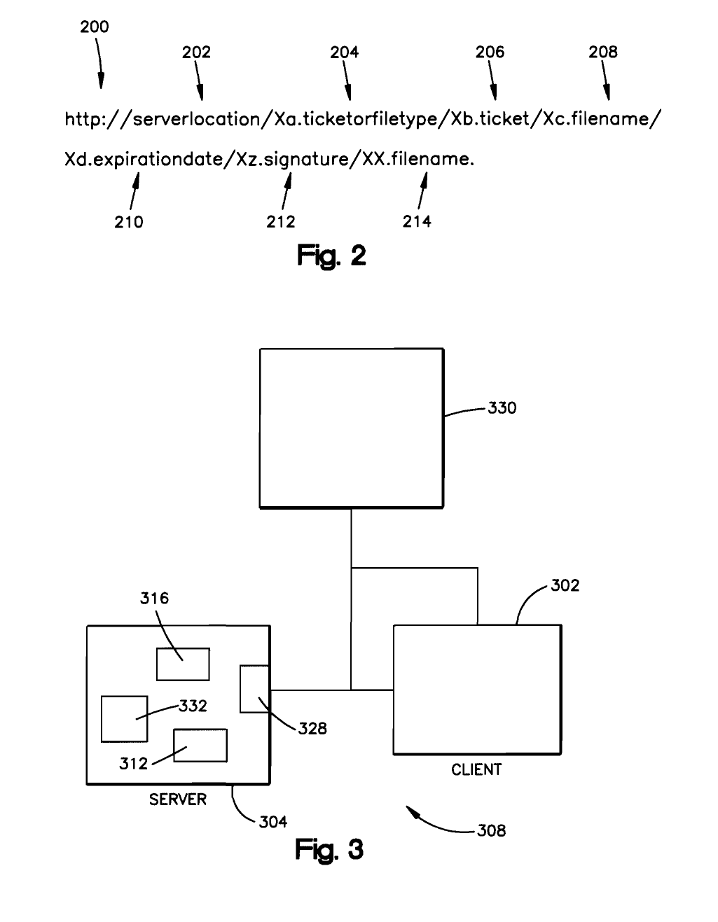

FIG. 2 illustrates an embodiment of a download URL 200 according to the present invention. The URL 200 is configured to enable the download of the file “XX.filename” 214 from a download server “http://serverlocation” 202 if the URL 200 is recognized as valid at 114. Each URL 200 also comprises a ticket parameter “Xb.ticket” 206, a file name parameter “Xc.filename” 208, and an expiration date parameter “Xd.expirationdate” 210. Other parameters may also be optionally included, such as for example the file or ticket type parameter “Xa.ticketorfiletype” 204 illustrated herein. The parameters 204,206,208,210 are contained within a signed string of parameters, signed with a secure signature parameter “Xz.signature” 212.

Validation of the URL 200 by the download server “http://serverlocation” 202 at 114 is dependent the URL parameters 204, 206, 208, 210 and 212. In a first instance URL 200 validity is dependent upon the integrity of the signed string 204,206,208,210,212, wherein the field values of the parameters Xa 204 through the signature parameter Xz 212 are protected through private key cryptography or other encryption and security systems and methods. The URL 200 repeats the filename 214 as the filename parameter Xc 208 within the secured string, and the filename 214 must match the filename parameter 208 within the secured string, otherwise the URL is invalidated at 114 and the download request rejected, ending the process at 115. Thus the signed secure string 204,206,208,210,212 is unique for each file through inclusion of the filename parameter 208. This prevents misuse of an otherwise valid secured string 204,206,208,210,212 by preventing its use to download a different file.

Validity of the URL 200 is dependent in a second instance upon a fixed time period defined by the expiration date parameter Xd 210, wherein an initial validation and authorization at 104 is effectively terminated after a fixed period determined by the expiration date parameter Xd 210. An attempted download after expiration of the fixed period is denied at 114 as from an expired URL link 200, and the process ended at 115. This provides advantages in reducing the probability of improper use of a valid secure URL 200 by requiring confirmation of download permissions through requiring the party to repeat demographic information input at 102 and validation at 104 after expiration of the fixed period. The fixed period may be any appropriate time period as desired by a network administrator or required by governmental authorities; illustrative examples include five days or two weeks.

Thus according to the present invention the URL 200 enables validated file downloading from the download server for a file identified at 214 and also within the secure string 204,206,208,210,212 for a fixed time period determined by the expiration parameter 210. In one advantage the URL 200 enables downloads independent of the actual temporal location (for example, IP address) of a validated downloader. Thus an interrupted download session may be resumed by a subsequent second download request from a different IP address location through the same valid URL 200, even though the second request IP address no longer correlates with the physical location of the original validated download request. Not only does this obviate the need for a backend server validation procedure, it avoids the possibility that the request itself is improperly failed through a backend server routines in response to observing the divergent IP addresses.

In the present embodiment an “Xa.ticketorfiletype” parameter 204 is optionally provided to identify an export level associated the file 214 and/or the party identified by the ticket 206. For example, wherein some files and/or parties may have a first export level designation signified by a first Xa parameter 204, other files and/or parties may have a different second export level designation signified by a second Xa parameter 204. However, it is to be understood that these characteristics may alternatively be identified in each party ticket 206, thus allowing omission of export level parameters 204.

The present invention also provides advantages in download activity reporting. Generally when a connection is created between a download client and a server, the server must identify who the client is and also track the file content being downloaded. And prior art methods must generally identify demographic information whenever a file is downloaded by using a backend server to perform a lookup routine for every single download session. In contrast, according to the present invention no backend server lookup is required, since reference to all of the party's demographic information is already built into each URL 200. More particularly, through use and incorporation of the unique ticket parameter 206 within each URL 200 only an index/logging process step 120 is required for each download request or session: no backend server lookup resource or routine is required.

The unique ticket 206 may be used to log all download activity associated with the associated unique downloading party. The ticket 206 is unique for each downloading party and/or file and provides a pointer to downloading party demographic information stored at the time the download page was created at 110. In one embodiment the ticket 206 is an index to a network file provider database entry containing the party demographic information, wherein at the completion of a successful file download a logging flat file for the download session is created at 120, the flat file containing the ticket 206.

Download reports, for example those required by governmental export requirements, may then be easily created at 122 by collecting all logging flat files into one database and creating the requisite report through database indexing methods. Thus in one example a party export report for one file product may be easily and rapidly generated by identifying the file by filename 214, searching a database for all entries for file download sessions; compiling all tickets 206 associated with all of the file download sessions; and generating an export file for that product listing all users identified from the tickets 206.

Advantages in the collection and reporting of downloader demographics are provided by collecting this information once at an initial validation process at 104. As demographic data may change from one download session to another, it is important to keep the demographic data used for each session, and accordingly an update of party demographic data will result in a new record for the party without altering an old record. Thus party's identity is not a name or customer number but instead a ticket tag 206 in the URL link 200 that identifies the current demographic state of the party at all times. And as the download link 200 includes others tags 204, 208 that identify the export level of the download and the product, respectively, the URL 200 allows a large volume of data (party demographic information, product descriptions, download statistics, etc.) to be reduced to a single pointer to a party's demographic information, a single pointer to a product description, and a small collection of file download entries that are easily combined for the reporting, thus minimizing the overhead of collecting and sorting numerous downloads for creating a download report.

At export report time, the user information may be looked up from the tickets 206 in the download logs and a report can be made that shows the user's demographic data at the time of the download, the filename, and the product information from the filename. In database terms, the user data is mapped as one to many in the download logs, thus providing resource efficiencies by reducing storage requirements, as contrasted with prior art systems and methods that require storage of user demographic information for each download. The present invention also enables a file download to be broken up into multiple segments done over days without a need to access a party's demographic information at the time of each download session, thus improving system efficiencies, convenience to the party and general availability of the downloads to the party.

Further advantages are provided for logging download activity involving download aids and/or multiple connections. A download aid may be used to download a file by using multiple network connections, for example in some cases thousands of connections. As every connection used to download the file 214 will be associated with the ticket 206, it is very easy to combine these thousands of individual download entries into a single entry that identifies the file and downloading party: no duplicate demographic data entry must be created for every download session, as is typically required under prior art download aid methods and systems.

A combined set of downloads may be logged as a single entry at 120 or 122. Furthermore, where a party downloads multiple files by using multiple URL links 200 presented on the download page 111, each download URL 200 ticket 206 identifies and points to the party's demographic information file: thus a single party demographic file entry may be used for all of downloaded files, each URL 200 ticket 206 serving as a pointer sufficient to track the party and connect him to each file download. Thus all required demographic information is effectively self-contained within the dynamically-created URL 200, eliminating backend server tracking and identification processing steps.

### II. Computerized Implementation

Referring now to FIG. 3, an exemplary computerized implementation of the present invention includes a network download server 304 in communication with a client device 302 requesting download of a file residing in a memory 316 or a storage system 332 through a computer network infrastructure 308. Another server resource 330 is provided for demographic information compilation and/or verification, database index functions or other aspects of the present invention as discussed above. The implementation is intended to demonstrate, among other things, that the present invention could be implemented within a network environment (e.g., the Internet, a wide area network (WAN), a local area network (LAN) or a virtual private network (VPN), etc. Communication throughout the network 308 can occur via any combination of various types of communications links: for example, communication links can comprise addressable connections that may utilize any combination of wired and/or wireless transmission methods.

Where communications occur via the Internet, connectivity could be provided by conventional TCP/IP sockets-based protocol, and an Internet service provider could be used to establish connectivity to the Internet. Still yet, the network infrastructure 308 is intended to demonstrate that the file download application can be deployed, managed, serviced, etc. by a service provider who offers to implement, deploy, and/or perform the functions of the present invention for others.

The network computers 304 and 330 both comprise various components, some of which are illustrated in the download server 304; it is to be understood that the server 330 may comprise the same or more components. More particularly, as shown the network computer 304 includes a processing unit 312 in communication with one or more external I/O devices/resources 328 and storage systems 332. In general, the processing unit 312 executes computer program code, such as the code to implement one or more of the file download process steps illustrated in FIG. 1, which is stored in the memory 316 and/or the storage system 332.

The network infrastructure 308 is only illustrative of various types of computer infrastructures for implementing the invention. For example, in one embodiment, computer infrastructure 308 comprises two or more computing devices (e.g., a server cluster) that communicate over a network. Moreover, the download computer 304 is only representative of various possible computer systems that can include numerous combinations of hardware. To this extent, in other embodiments, the network computer 304 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations. Further, I/O interfaces 328 can comprise any system for exchanging information with one or more of the external server 330 and client 302. Still further, it is understood that one or more additional components (e.g., system software, math co-processing unit, etc.) not shown in FIG. 3 can be included in the computers 304, 330 and client 302.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into the network computer 304.

While shown and described herein as a method and system for file downloading, it is understood that the invention further provides various alternative embodiments. For example, in one embodiment, the invention provides a computer-readable/useable medium that includes computer program code to enable a computer infrastructure to provide the file downloading processes, systems and articles (i.e. unique URL links) described above. To this extent, the computer-readable/useable medium includes program code that implements each of the various process steps of the invention.

It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider could offer to manage file downloading. In this case, the service provider can create, maintain, and support, etc., a computer infrastructure, such as the network computer infrastructure 308 that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for executing one or more of the file downloading processes, systems and articles described above. In this case, a computer infrastructure, such as the computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as the computers 304/330, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method, comprising:
creating a first file download URL comprising at least a first file name parameter and a first party pointer;
the first party using the URL to navigate to a download server through a communication medium from a first IP address, the download server comprising the first file;
the download server downloading or not downloading the first file to the first party in response to at least one of the first file name parameter and the first party pointer without communicating with a backend server or performing a first party demographic information look-up; and
logging a complete download of the file to a first party pointer database file.

2. The method of claim 1 further comprising the step of associating the first party pointer with first party demographic information, wherein the step of creating the first file download URL is dependent upon approval of the first party demographic information in view of a download permission rule.

3. The method of claim 2, further comprising the step of forming the first file download URL with a signed parameter string comprising the first file name parameter and the first party pointer, and a first filename reference outside of the signed string; and
wherein the step of the download server downloading or not downloading the first file further comprises comparing the signed string first file name parameter to the first filename reference and not downloading the first file if the signed string first file name parameter does not match the first filename reference.

4. The method of claim 3, wherein the signed parameter string further comprises an expiration date parameter; and
wherein the step of the download server downloading or not downloading the first file further comprises the download server determining an elapsed time from the expiration date parameter and not downloading the first file if the elapsed time exceeds a permitted time period.

5. The method of claim 4 further comprising the steps of:
the first party using the URL to navigate to the download server through a communication medium from a second IP address, the first and second IP addresses identified as originating from a common national entity; and
the download server resuming downloading of the first file to the first party without communicating with a backend server or performing a first party demographic information look-up.

6. The method of claim 4 wherein the signed parameter string further comprises a file type parameter; and
wherein the step of the creating the first file download URL in view of the download permission rule is dependent upon approval of the first party demographic information in view of the file type parameter.

7. The method of claim 4 further comprising the steps of:
searching a database comprising a plurality of party pointers for party pointers associated with a successful download of the first file;
compiling all party pointers associated with successful downloads of the first file; and
generating an export file for the first file listing all parties from demographic information indexed by each of the party pointers associated with successful downloads.

8. The method of claim 7 wherein the step of creating the first file download URL further comprises storing first party demographic information in a database, wherein the first party pointer points to the stored first party demographic information.

9. A system, comprising:
a download server configured to download or not download a first file to first party navigating to the download server through a communication medium from a first IP address by using a first file download URL without communicating with a backend server or performing a first party demographic information look-up;
wherein the download server is further configured to download or not download the first file in response to determining whether the URL is valid.

10. The system of claim 9 wherein the download server is further configured to log a flat file into a database in response a complete download of the first file to the first party.

11. The system of claim 10 wherein the first file download URL comprises a signed parameter string comprising a first file name parameter and a first party pointer, and a first filename reference outside of the signed string;
wherein the first party pointer is associated with first party demographic information stored in a database demographic file.

12. The system of claim 11 wherein the signed parameter string further comprises an expiration date parameter; and
wherein the download server is configured to determine an elapsed time from the expiration date parameter and not download the first file to the first party if the elapsed time exceeds a permitted time period.

13. The system of claim 12 wherein the download server is further configured to resume downloading of the first file to the first party to a second IP address without communicating with a backend server or performing a first party demographic information look-up, wherein the first and second IP addresses originate from a common national entity.

14. The system of claim 12 further comprising a reporting component configured to compile all party pointers associated with successful downloads of the first file and generate an export file for the first file listing all parties from demographic information indexed by each of the party pointers associated with successful downloads.

15. The system of claim 12 wherein the signed parameter string further comprises a file type parameter.

16. A method comprising:
providing computer executable program code to be deployed to and executed on a computer system;
the program code comprising instructions which, when executed on the computer system, causes the computer system to:
create a first file download URL comprising at least a first file name parameter and a first party pointer;
cause a download server to download or not download a first file to a first party client in response to the client navigating to the download server through use of the first file download URL in response to at least one of a first file download URL first file name parameter and a first file download URL first party pointer without communicating with a backend server or performing a first party demographic information look-up; and
cause the download server to log a complete download of the file to a first party pointer database file.

17. The method of claim 16 wherein the program code, when executed on the computer system, further causes the computer system to:
associate the first party pointer with first party demographic information; and
create the first file download URL dependent upon approval of the first party demographic information in view of a download permission rule.

18. The method of claim 17 wherein the program code, when executed on the computer system, further causes the computer system to:
form the first file download URL with a signed parameter string comprising the first file name parameter and the first party pointer, and a first filename reference outside of the signed string; and
cause the download server to compare the signed string first file name parameter to the first filename reference and not download the first file if the signed string first file name parameter does not match the first filename reference.

19. The method of claim 18 wherein the program code, when executed on the computer system, further causes the computer system to:
form the first file download URL signed parameter string with an expiration date parameter; and
cause the download server to determine an elapsed time from the expiration date parameter and not download the first file if the elapsed time exceeds a permitted time period.

20. The method of claim 19 wherein the program code, when executed on the computer system, further causes the computer system to:
search a database comprising a plurality of party pointers for party pointers associated with a successful download of the first file;
compile all party pointers associated with successful downloads of the first file; and
generate an export file for the first file listing all parties from demographic information indexed by each of the party pointers associated with successful downloads.
